(19) United States
(12) Patent Application Publication
(10) Pub. No.: US 2016/0280292 A1
(43) Pub. Date: Sep. 29, 2016

(54) Two Track Tractor with an Active Suspension System for Reducing Pitch Jerk and Method of Use Thereof by Executing Computer-Executable Instructions Stored On a Non-Transitory Computer-Readable Medium

(71) Applicant: Ronald L. Satzler, Princeville, IL (US)

(72) Inventor: Ronald L. Satzler, Princeville, IL (US)

(21) Appl. No.: 15/081,833

(22) Filed: Mar. 25, 2016

Related U.S. Application Data
(60) Provisional application No. 62/137,931, filed on Mar. 25, 2015.

(51) Int. Cl. B62D 55/116; B60W 30/02; B62D 55/02

(52) U.S. Cl. CPC B62D 55/116; B62D 55/02; B60W 30/02

(57) ABSTRACT

A two track tractor with an active suspension system for reducing pitch jerk and a method of operation thereof utilizes a position sensor between a nose of the tractor and a front axle assembly connected to a forward rolling element. The gap between the nose and the front axle is continually measured and an average gap value is produced. An active suspension system is controlled by a microprocessor to vary the pitch angle between the tractor body and the axle assembly in order to maintain a target nose gap while limiting the pitch jerk experienced by the operator.

The current application claims a priority to the U.S. Provisional Patent application Ser. No. 62/137,931 filed on Mar. 25, 2015.

### FIELD OF THE INVENTION

The present invention relates generally to a method and apparatus for use with tractors. More specifically, the present invention limits the amplitude and frequency of jerk that occurs during field operations of a two track tractor.

### BACKGROUND OF THE INVENTION

Caterpillar developed a two track agricultural tractor with rubber belts that travels at higher speeds than steel tracks. The rubber belt tracks generate much less vibration than steel tracks. Compared to steel tracks, the rubber belt tracks greatly reduce the damage done to road surfaces.

Both uneven terrains and rough ground surfaces cause the two-track tractor to pitch about a lateral axis. Pitch is rotation about a lateral axis in either the forward direction or the rearward direction: counterclockwise (CCW) or clockwise (CW). Typically, the amount of rotation is a small number of degrees occurring frequently or a large amount of rotation occurring infrequently. Rotational acceleration, deceleration, and jerk are involved as the tractor seeks to maintain a position parallel to the ground's uneven surface.

Jerk is a technical term describing the rate of change of acceleration. Jerk causes discomfort to the tractor's operator. Ground uneven surface is generally caused by certain tillage operations, such as plowing or ripping, or soil erosion. Ground uneven surface typically produces a rapid reoccurrence of small jerks. This is tiring to the operator.

Uneven terrain is either concave or convex in nature. A convex terrain, having a small radius of curvature (terrace top for example) coupled with typical fieldwork speeds, causes the two-track tractor to pitch forward violently as the tractor passes beyond the high point of the convex. The resulting jerk that starts and stops the forward pitch is high magnitude because the forward pitch starts and stops suddenly. In turn, the operator experiences a high level of discomfort. Without a seatbelt, the operator could be thrown against the tractor's components and injured. This generally infrequent occurrence of jerk may not be tiring but it is unpleasant and dangerous without a seatbelt.

Ground surface roughness in Ag fields consists of random patterns of raised bumps, recesses, and ruts. Typically, a tractor's wheel will lift when traversing the raised bump and lower when traversing the recesses and ruts. Pneumatic tires have built-in springs that will both compress and extend as the ground surface roughness is encountered. The spring of the tire will absorb vertical travel, allow extra downward movement of the tractor, and launch the tractor upward.

Typically, the wheel tractor has either single or dual tires at each of its four corners. Each tire acts independently to lift, lower, and launch upward. The operator feels an ongoing random pattern of pitch, roll, and bounce. This is an ongoing discomfort for the operator to endure.

A tractor having two tracks tends to bridge the recesses and ruts. This greatly reduces the roll and bounce. Some pitch is generally experienced as the front idler of each track encounters high spots and ruts. Some operator discomfort is experienced from this pitching.

A half-track tractor typically has the operator nearly above the tracks and thus the roll and bounce are reduced. The tires up front tend to generate pitch. Moderate to severe operator discomfort can be experienced from pitching caused by the front tires.

It is therefore an object of the present invention to present an apparatus and method for reducing pitch jerk felt by the operator of a two track tractor.

### BRIEF DESCRIPTION OF THE DRAWINGS

FIG. 1 is a perspective view of the apparatus of the present invention.

FIG. 2 is an interior perspective view of the apparatus of the present invention.

FIG. 3 is an interior side view showing the active suspension of the apparatus of the present invention.

FIG. 4 is an interior perspective view showing the position sensor of the apparatus of the present invention.

FIG. 5 is an interior side view showing the position sensor of the apparatus of the present invention.

FIG. 6 is an interior rear view of one of the rolling elements of the apparatus of the present invention.

FIG. 7 is an interior view showing the accelerometer of the apparatus of the present invention.

FIG. 8 is a side view of the apparatus of the present invention demonstrating a max stroke position of the active suspension.

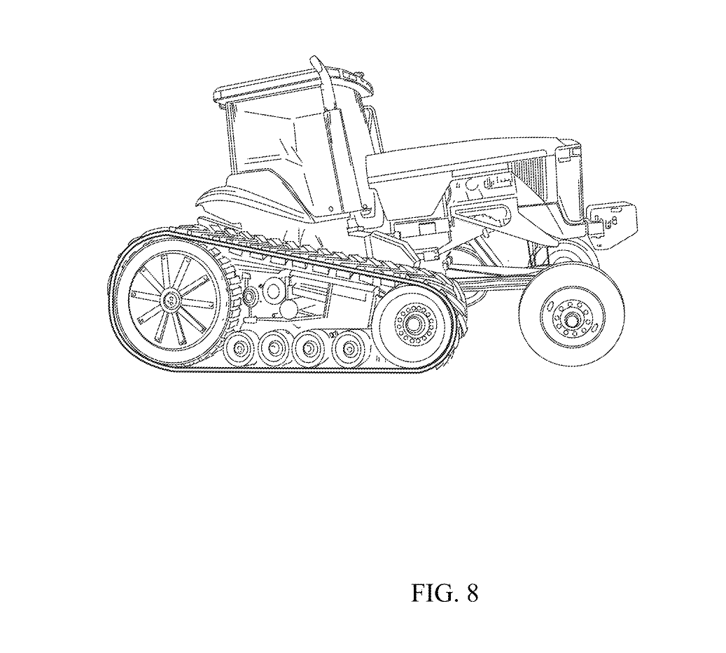

FIG. 9 is a schematic diagram of the electrical components of the present invention.

FIG. 10 is a stepwise flow diagram of the general method of the present invention.

FIG. 11 is a stepwise flow diagram showing additional steps in the method of the present invention.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced without the implementation of some features as they are described. It should be understood that some details have not been described in detail in order to not unnecessarily obscure focus of the invention.

The present invention is a configuration for a two track tractor with an active suspension system for reducing pitch jerk felt by the tractor's operator and a method of operating the active suspension system in order to achieve said pitch jerk reduction. The present invention limits the amplitude and frequency of jerk that occurs during field operations of a two track tractor. This results in ultimate ride comfort for the operator. Excessive vertical jerk at the nose is the main cause of discomfort to the operator.

The present invention combines state of the art components in a way that adds value to the tractor. Operator ride comfort is the greatest value added. Other values added include simplicity, dual purpose components, light weight, and low cost. This new idea relies mainly on a position sensor, an accelerometer an active suspension system, and a digital processing unit such as, but not limited to, a microprocessor.

The present invention seeks to maintain a specified vertical height of the nose of the tractor above the ground. The position sensor measures the instantaneous height of the tractor's nose above the ground. To do this, a potentiometer is connected between the nose and the front axle assembly. The front axle assembly is an Ackerman axle in the preferred embodiment, though other axle configurations may be comprised in the present invention according to the spirit of the present invention. The front axle has no vertical connection to the nose other than a stop pad. The specified vertical height allots about a specified gap, such as, but not limited to, two inches, between the nose and the stop pad.

Ground surface roughness and varying ground curvature produces a jagged height position signal input into the microprocessor. This new idea programs the microprocessor to average the jagged height position signal: creating a smooth curve that defines an averaged current height of the tractor's nose above the ground. The output of the microprocessor seeks to continually correct any error between prescribed height of the tractor's nose and the averaged current height of the tractor's nose.

The microprocessor controls a hydraulic system (counterbalance moment system) that can vary the height of the tractor's nose. The rate of error correction is low enough to not create sensed discomfort to the operator. One purpose of the accelerometer is to keep the jerk involved in the error correction low.

The general configuration of a two track tractor of the present invention should be well known to those skilled in the art and does not need to be specified in extreme detail. The present invention adds a forward rolling element in addition to the double track assemblies of typical two track tractors with a gap between the forward rolling element and the nose of the tractor.

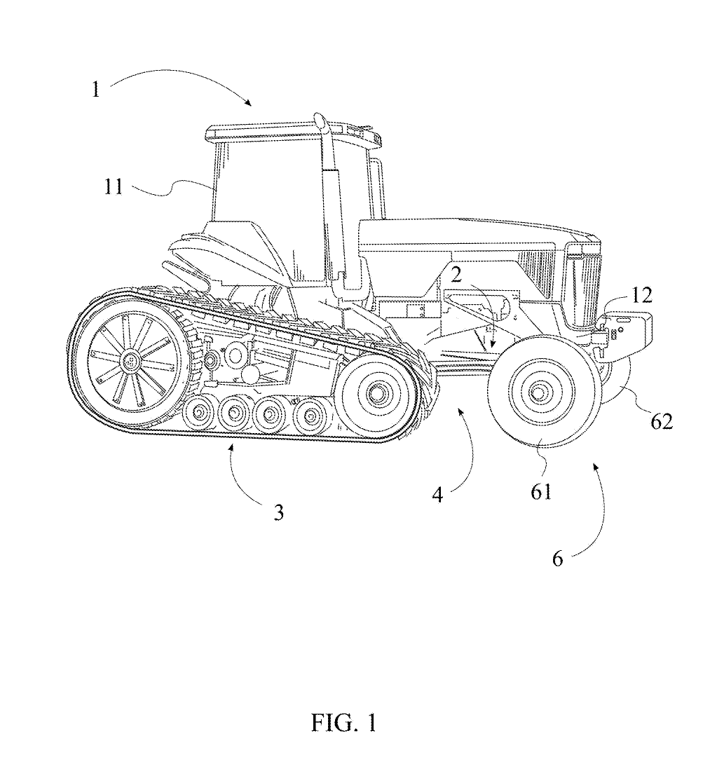

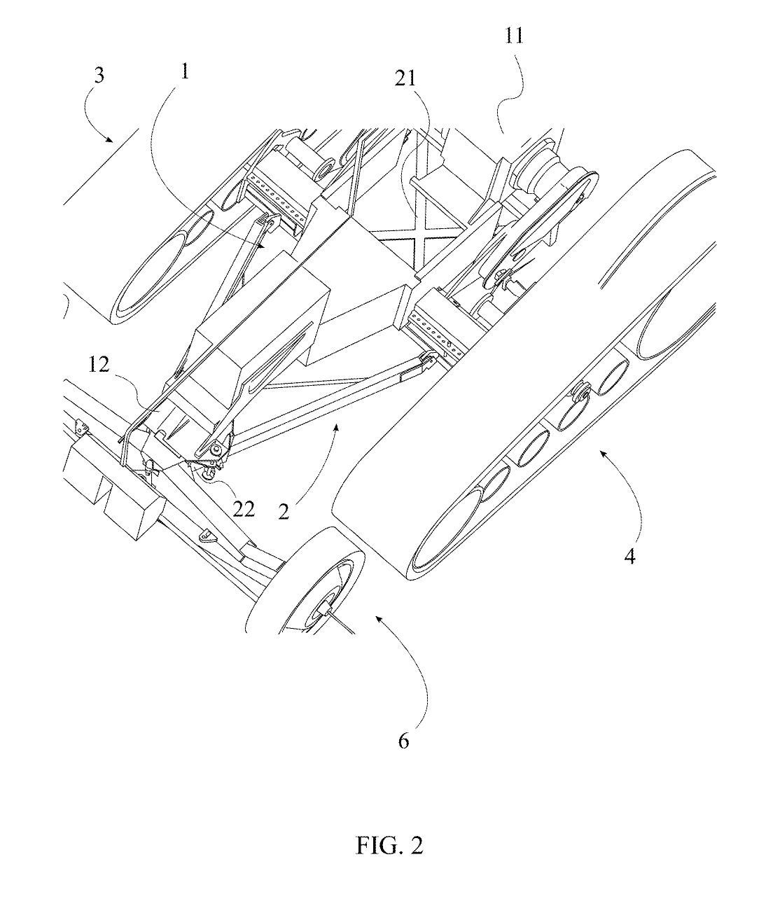

In general, referring to FIGS. 1-7, the two track tractor of the present invention comprises a tractor body 1, an axle assembly 2, a first rolling element 3, a second rolling element 4, an active suspension system 5, a position sensor 7, an accelerometer 8, and a microprocessor 9.

The tractor body 1 comprises a main body portion 11 and a nose 12. The axle assembly 2 comprises a rear axle portion 21 and a forward axle portion 22. The rear axle portion 21 is laterally connected to the first element and the second rolling element 4, with the first rolling element 3 and the second rolling element 4 being positioned opposite each other across the rear axle portion 21. In the preferred embodiment of the present invention, the first rolling element 3 and the second rolling element 4 are rolling track assemblies typical to two track tractors. It is contemplated, however, that other rolling elements, such as, but not limited to, wheels, may potentially be comprised as the first rolling element 3 and the second rolling element 4 in various embodiments of the present invention without departing from the spirit and scope of the present invention.

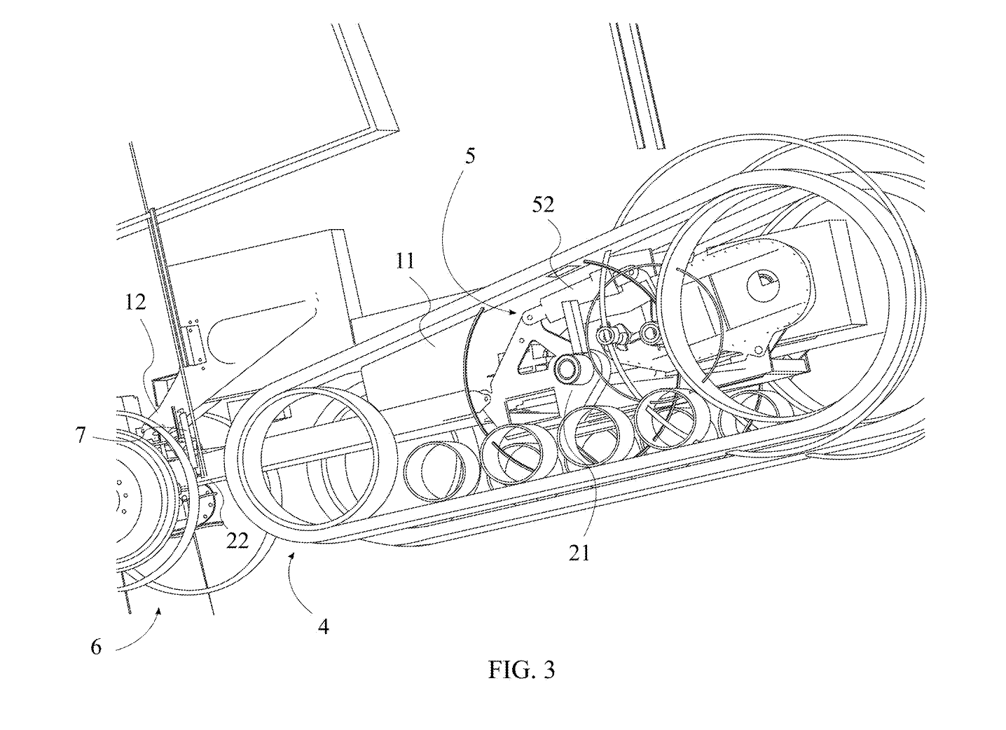

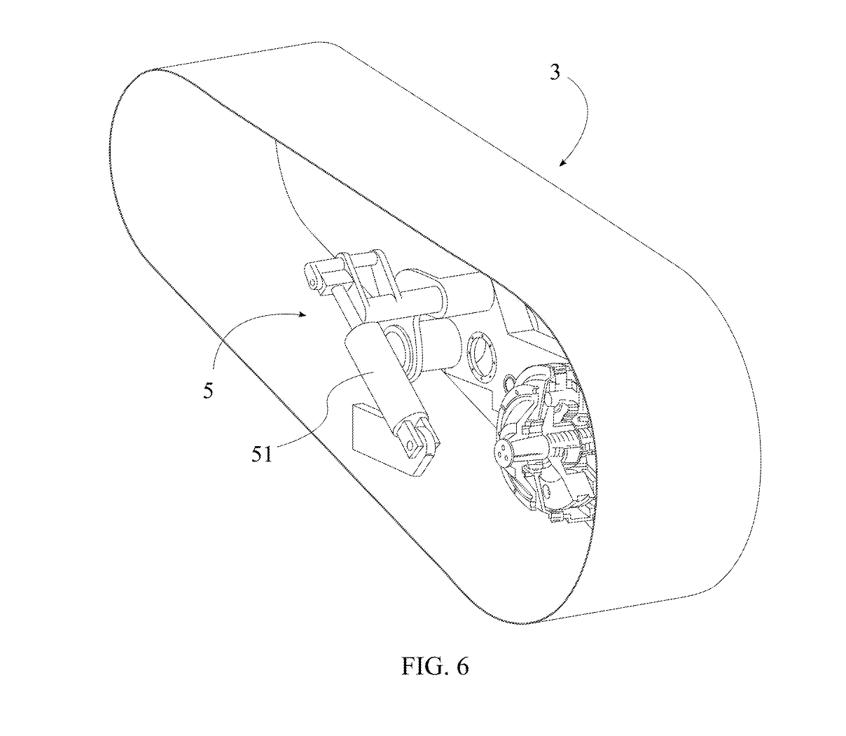

The active suspension system 5, understood to those skilled in the art, is operatively connected between the main body portion 11 and the first rolling element 3 and the second rolling element 4 as shown in FIG. 3, with the active suspension system 5 being configured to control a pitch angle between the tractor body 1, and the first rolling element 3 and the second rolling element 4. In one preferred embodiment, the active suspension system 5 is a hydraulic suspension system. Thus, as can be seen in FIGS. 3 and 6, the active suspension system 5 comprises a first hydraulic cylinder 51 and a second hydraulic cylinder 52, the first hydraulic cylinder 51 being operatively connected between the main body and the first rolling element 3, and the second hydraulic cylinder 52 being operatively connected between the main body and the second rolling element 4.

The first hydraulic cylinder 51 and the second hydraulic cylinder 52 constitute a counterbalance moment mechanism of the active suspension system 5.

At least one forward rolling element 6 is rotatably connected to the forward axle portion 22 in the present invention. The forward axle portion 22 and the at least one forward rolling element 6 are important to the functionality of the present invention, as will be understood and described hereinafter. In one embodiment, the at least one forward rolling element 6 is at least one wheel. In one embodiment, the at least one wheel comprises a first wheel 61 and a second wheel 62, with the first wheel 61 and the second wheel 62 being positioned laterally opposite each other across the forward axle portion 22. However, it is contemplated that any type of rolling element, such as, but not limited to, a track assembly, is sufficient to fulfill the purpose and spirit of the present invention.

The front axle moves up and down as it traverses the rough surface of the ground or uneven terrain. The jagged signal produced by the up and down movement of the front axle portion is averaged by the microprocessor 9 for the past short period of time (for example last 1 second). The calculated average becomes the target used to maintain the gap.

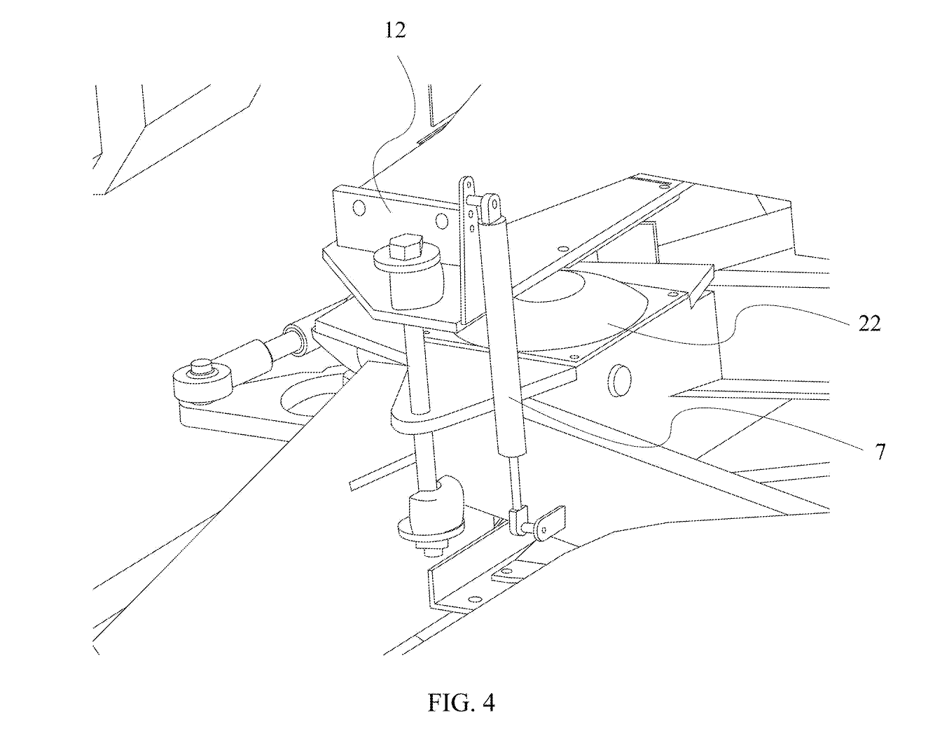

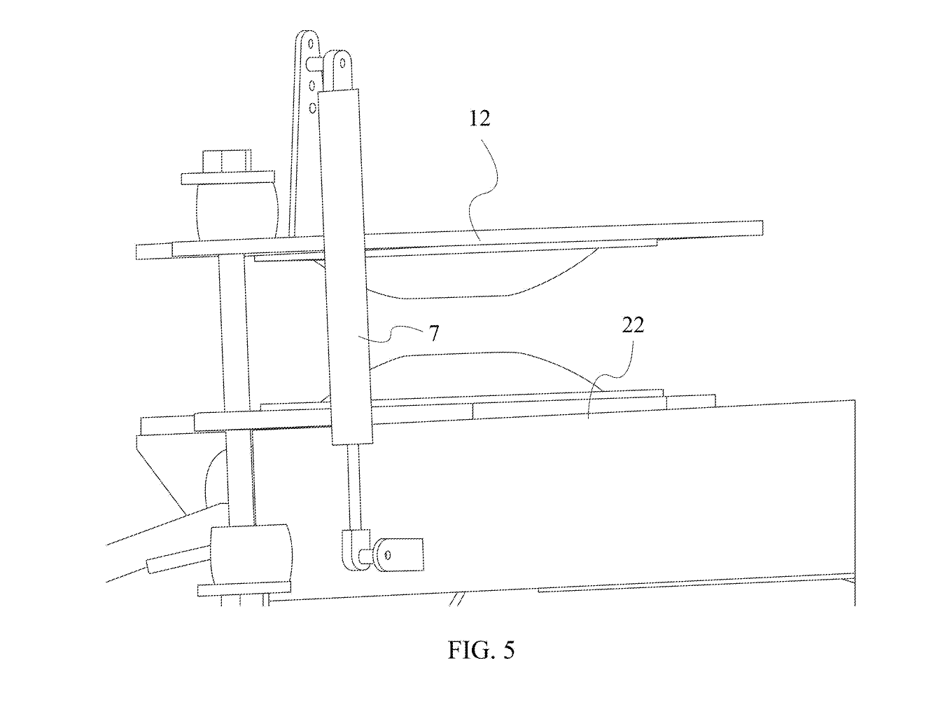

The nose 12 of the main body is vertically separated from the forward axle portion 22 by a nose gap. As shown in FIG. 4-5, a position sensor 7 is operatively engaged between the nose 12 and the forward portion, more particularly between a stop pad on the underside of the nose 12 and a stop pad positioned atop the forward axle portion 22 directly under the stop pad of the nose 12. In one embodiment, the position sensor 7 is a linear potentiometer connected between the nose 12 and the forward axle portion 22. In other embodiments, the position sensor 7 may be any other type of sensor which is capable of ascertaining the length of the nose gap between the nose 12 and the forward axle portion 22, such as, but not limited to, a capacitive displacement sensor, a laser rangefinder sensor or other photoelectric or optical sensors, an inductive sensor, a magnetic sensor, or other sensors. The ability to determine the vertical distance between the nose 12 and the forward axle portion 22 is crucial to the spirit and purpose of the present invention. The value of the nose gap distance can be correlated with the pitch angle through geometrical calculations, and thus the pitch angle can be accurately determined and controlled by measuring the nose gap distance.

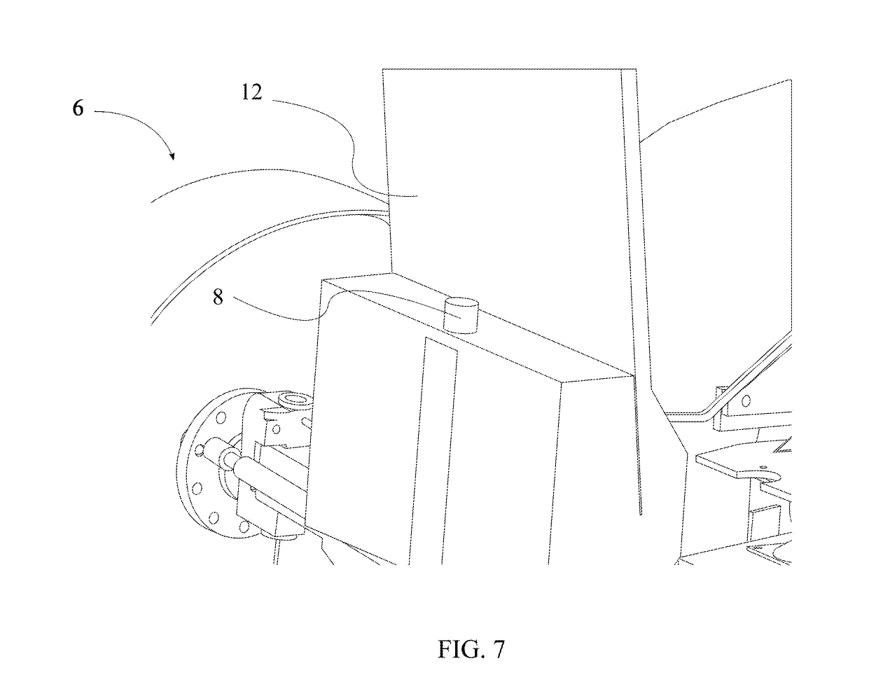

Furthermore, an accelerometer 8 is connected to the nose 12 as shown in FIG. 7. The accelerometer 8 is also important to the spirit and scope of the present invention in relation to minimizing the pitch jerk felt by the operator of the two track tractor. The accelerometer 8 measures the acceleration experienced at the nose 12, from which the jerk can be calculated and thus mitigated.

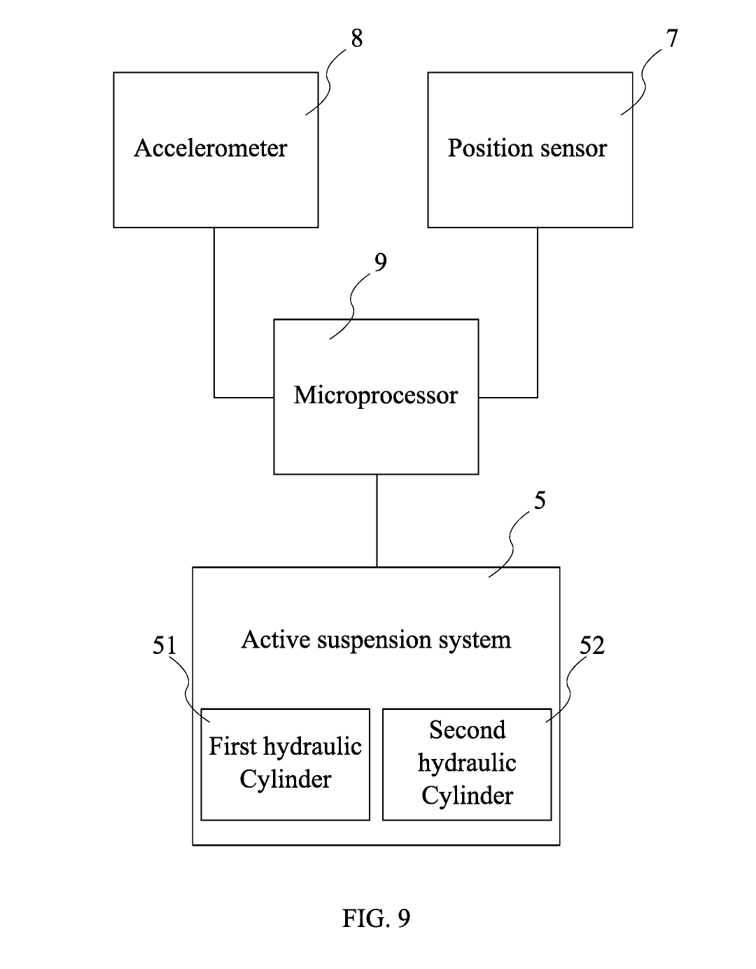

Finally, in reference to FIG. 9, a microprocessor 9 is electronically connected to the accelerometer 8, the position sensor 7, and the active suspension system 5. The microprocessor 9 receives inputs from the position sensor 7 and the accelerometer 8, and produce outputs to the electro-hydraulic valves that actuate the hydraulic cylinders of the active suspension system 5. The microprocessor 9 executes computer-executable instructions using the inputs from the position sensor 7 and the accelerometer 8 to produce the outputs to the active suspension system 5. It should be noted that the microprocessor 9 may be embodied as any electronic processing unit capable of accomplishing the aforementioned purpose, and should not be specifically limited to being a “microprocessor 9,” and may be any integrated circuit, combination of integrated circuits, processing units, or combinations thereof which can accept digital data or binary data, process the data according to instructions stored in its memory, and provide results as output.

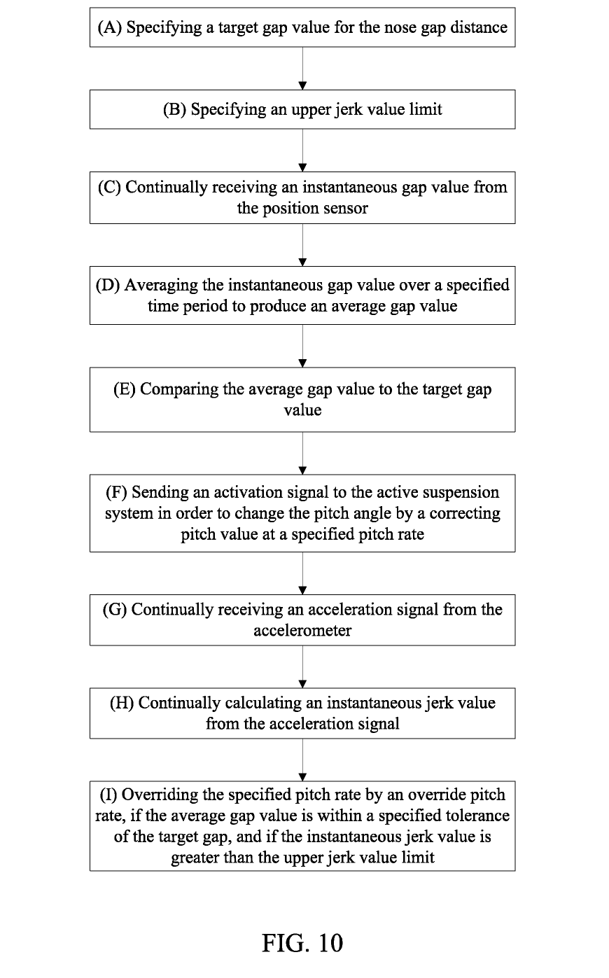

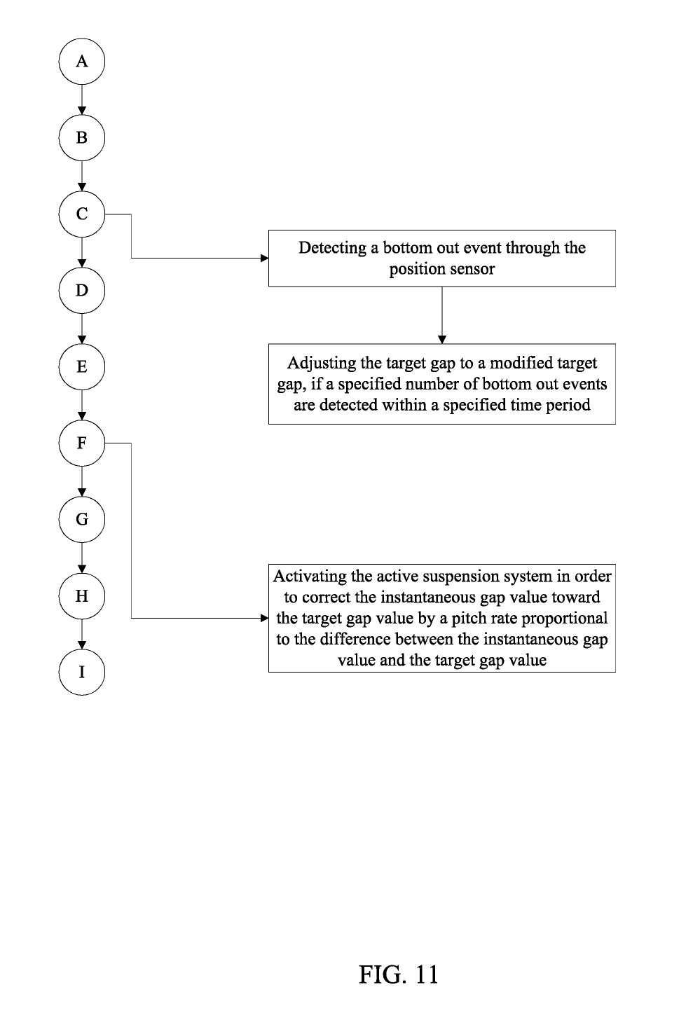

Referring to FIGS. 10-11, in the computer executable process of the present invention, a target gap is specified for the nose gap distance. The target gap may be specified to any desired value; for example, the target gap may be specified to two inches, and it may be desirable for the target gap to be specified to different values in different applications of the present invention. Additionally, an upper jerk value limit is specified. The upper jerk value limit dictates the maximum rate of change of acceleration the present invention seeks to allow the operator to experience.

An instantaneous gap value is continually received from the positions sensor, and the instantaneous gap value is averaged over a specified time period to produce an average gap value. The specified time period may conceivably be any time interval, though it is contemplated that a relatively small time period is ideal, such as, but not limited to, one second.

The average gap value is compared to the target gap value in order to ascertain if any corrections should be made to the pitch angle in order to maintain the target gap value. In one embodiment, the difference between the average gap value and the target gap value must be greater than a specified tolerance of the target gap in order for corrections to the pitch angle be triggered. In another embodiment, the system of the present invention is continually making corrections.

In order to make a correction to the nose gap distance, an activation signal is sent to the active suspension system 5 by the microprocessor 9 in order to change the pitch angle by a correcting pitch value. The correcting pitch value corresponds to the difference between the average gap value and the target gap value, which is converted from linear distance into an angular value, the conversion determined by the geometry of the system. The pitch angle is changed at a specified pitch rate that corresponds to a pitch angle jerk less than the upper jerk value limit. Thus, the measured average gap value is continually maintained or attempted to be maintained near the target gap value without significant discomfort to the operator due to pitch jerk over rough terrain. In one embodiment, the active suspension system 5 is activated in order to correct the instantaneous gap value toward the target gap value by a pitch rate proportional to the difference between the instantaneous gap value and the target gap value. In another embodiment, the pitch rate is constant for all situations.

The accelerometer 8 additionally plays a role in mitigating uncomfortable pitch jerk experienced by the operator. An acceleration signal is continually received from the accelerometer 8, and an instantaneous jerk value is continually calculated from the acceleration signal. If the accelerometer 8 detects excessive jerk at the nose 12, the microprocessor 9 activates the active suspension system 5 to correct.

It is conceivable that the front tires and the front of the track assemblies could raise or lower a precise amount at the same instant of time while the position sensor 7 records no change, even though significant jerk occurs at the nose 12. In this case the accelerometer 8 senses the situation and overrides the zero error target signal from the potentiometer. The override limits the amount of jerk the nose 12 of the tractor will experience. More specifically, in this situation any specified pitch rate previously determined by the microprocessor 9 from the nose gap distance is overridden by an override pitch rate if the average gap value is within a specified tolerance of the target gap, and if the instantaneous jerk value is greater than the upper jerk value limit. The override pitch rate corresponds with a pitch jerk value less than the upper jerk value limit.

The override pitch rate may either increase or decrease the pitch angle, depending on the situation. For example, if both the forward rolling element 6 and the front of the track assemblies simultaneously are raised by separate sudden inclines in the terrain, the microprocessor 9 will signal the active suspension system 5 to mitigate the jerk experienced by the nose 12 by collapsing the hydraulic cylinders, and reducing the pitch angle, thus mitigating the sudden upward pitch which would otherwise be experienced by the operator. Conversely, if both the forward rolling element 6 and the front of the track assemblies simultaneously fall into sudden depressions in the terrain, the microprocessor 9 will signal the active suspension system 5 to expand the hydraulic cylinders, increasing the pitch angle and reducing the otherwise sudden forward pitch.

Another potential feature of the present invention is a form of predictive error correction. A “bottom out” event is when the active suspension system 5 reaches either a maximum extension or a maximum contraction, or when the nose 12 and the front axle portion come into contact. Since the active suspension system 5 cannot mitigate bottom out events, a jerk is experienced by the operator. These bottom out events are detected through the position sensor 7, or through other applicable means. If a specified number of bottom out events are detected within a specified time period, the target gap may be adjusted to a modified target gap. For example, if multiple bottom out events are detected in a short period of time with an initial target gap of two inches, the target gap may be modified to three or more inches in order to attempt to prevent further bottom out events.

The position sensor 7, the hydraulic cylinders within the counterbalance moment mechanism, the accelerometer 8, and the microprocessor 9 forms an active suspension system 5 for the nose 12 of the tractors without adding a lot of extra hardware at the front of the tractor typically used by a more conventional active suspension system 5.

Although the invention has been explained in relation to its preferred embodiment, it is to be understood that many other possible modifications and variations can be made without departing from the spirit and scope of the invention as hereinafter claimed.

1. A two track tractor with an active suspension system for reducing pitch jerk comprises:
a tractor body comprising a main body portion and a nose;
an axle assembly comprising a rear axle portion and a forward axle portion;
a first rolling element and a second rolling element;
the rear axle portion being laterally connected to the first rolling element and the second rolling element, wherein the first rolling element and the second rolling element are positioned opposite each other across the rear axle portion;
an active suspension system being operatively connected between the main body portion and the first rolling element and the second rolling element, wherein the active suspension system controls a pitch angle between the tractor body and the axle assembly, first rolling element and second rolling element;
at least one forward rolling element being rotatably connected to the forward axle portion;
the nose being vertically separated from the forward axle portion by a suspension gap;
a position sensor being operatively engaged between the nose and the forward axle portion;
an accelerometer being connected to the nose; and
a microprocessor being electronically connected to the accelerometer, the position sensor, and the active suspension system.

2. The two track tractor with an active suspension system for reducing pitch jerk as claimed in claim 1 comprises:
the first rolling element and the second rolling element each being rolling track assemblies.

3. The two track tractor with an active suspension system for reducing pitch jerk as claimed in claim 1 comprises:
the at least one forward rolling element being at least one wheel.

4. The two track tractor with an active suspension system for reducing pitch jerk as claimed in claim 3 comprises:
the at least one wheel comprises a first wheel and a second wheel; and
the first wheel and the second wheel being positioned laterally opposite each other across the forward axle portion.

5. The two track tractor with an active suspension system for reducing pitch jerk as claimed in claim 1 comprises:
the active suspension system being a hydraulic suspension.

6. The two track tractor with an active suspension system for reducing pitch jerk as claimed in claim 5 comprises:
the active suspension system comprises a first hydraulic cylinder and a second hydraulic cylinder;
the first hydraulic cylinder being operatively connected between the main body and the first rolling element; and
the second hydraulic cylinder being operatively connected between the main body and the second rolling element.

7. The two track tractor with an active suspension system for reducing pitch jerk as claimed in claim 1 comprises:
the active suspension system comprising a counterbalance moment mechanism.

8. The two track tractor with an active suspension system for reducing pitch jerk as claimed in claim 1 comprises:
the position sensor being a linear potentiometer.

9. A method of reducing pitch jerk in a two track tractor with an active suspension system by executing computer-executable instructions stored on a non-transitory computer-readable medium comprises the steps of:
providing a two track tractor comprising a main body and an axle assembly, the main body comprising a nose, and the axle assembly comprising a forward axle portion, wherein the nose and the forward axle portion are separated by a nose gap distance, and wherein the main body and the axle assembly are oriented at a pitch angle relative to each other;
providing an active suspension system being operatively connected between the main body and the axle assembly, wherein the active suspension system controls the pitch angle between the main body and the axle assembly;
providing an accelerometer connected to the nose;
providing a position sensor, wherein the position sensor measures the nose gap distance, and wherein the nose gap distance correlates with the pitch angle;
specifying a target gap value for the nose gap distance;
specifying an upper jerk value limit;
continually receiving an instantaneous gap value from the position sensor;
averaging the instantaneous gap value over a specified time period to produce an average gap value;
comparing the average gap value to the target gap value;
sending an activation signal to the active suspension system in order to change the pitch angle by a correcting pitch value at a specified pitch rate, wherein the correcting pitch value corresponds to the difference between the average gap value and the target gap value, and wherein the specified pitch rate corresponds to a pitch angle jerk less than the upper jerk value limit;
continually receiving an acceleration signal from the accelerometer;
continually calculating an instantaneous jerk value from the acceleration signal;
overriding the specified pitch rate by an override pitch rate, if the average gap value is within a specified tolerance of the target gap, and if the instantaneous jerk value is greater than the upper jerk value limit, wherein the override pitch rate corresponds with a pitch jerk value less than the upper jerk value limit;

10. The method of reducing pitch jerk in a two track tractor by executing computer-executable instructions stored on a non-transitory computer-readable medium as claimed in claim 9 comprises the step of:
activating the active suspension system in order to correct the instantaneous gap value toward the target gap value by a pitch rate proportional to the difference between the instantaneous gap value and the target gap value.

11. The method of reducing pitch jerk in a two track tractor by executing computer-executable instructions stored on a non-transitory computer-readable medium as claimed in claim 9 comprises the steps of:
detecting a bottom out event through the position sensor, wherein the bottom out event occurs when the active suspension system reaches either a maximum extension or maximum contraction; and
adjusting the target gap to a modified target gap, if a specified number of bottom out events are detected within a specified time period.
